(19) United States
(12) Patent Application Publication
(10) Pub. No.: US 2008/0011782 A1
(43) Pub. Date: Jan. 17, 2008

(54) HAND PUMP DISPENSER AND HOLDER FOR DISPENSING LIQUID GELS AND PAPER TOWELS

(76) Inventor: Glenda Ann Sidman, Tequesta, FL (US)

Correspondence Address: Richard M. Blank, 19 Ledgewood Commons, Millwood, NY, 10546, US

(21) Appl. No.: 11/778,496

(22) Filed: Jul. 16, 2007

Related U.S. Application Data
(60) Provisional application No. 60/807,583, filed on Jul. 17, 2006.

(51) Int. Cl. B67D 5/06

(52) U.S. Cl. 222/192

(57) ABSTRACT

A hand pump dispenser and holder for liquid sanitizer gels and paper towels that is both functional and decorative. Having a base attached to an elongated cylindrical receptacle protruding from its center, that holds a paper towel roll vertically. The base has non-slip padding. A gel pouch container tube is attached to a hand pump assembly at the container's top, by a connector. The assembly has a conduit tube that protrudes down into the pouch. This assembly is inserted into the cylindrical receptacle and latched securely into place at the outlet aperture. The pump has a dispenser nozzle end which reaches over the paper towels to deliver gel. Gel is pumped up through the pump, dispensing the gel into the hands, and the excess is wiped off the hands by using the paper towels. Slots for salt and pepper shakers, napkins and condiments can be added to the device.

### RELATED APPLICATIONS

The present application claims the benefit under 35 U.S.C. §119(e) of the U.S. provisional application(s) listed here as 60/807,583 filed on Jul. 17, 2006 for A KITCHEN COUNTERTOP/RESTAURANT TABLE PAPER TOWEL HOLDER (WITH OR WITHOUT CONDIMENT ATTACHMENT), CONSISTING OF A TUBE THAT IS INSERTED THROUGH THE TOP HOLE OF THE STANDING PAPER TOWEL ROLL, THE TUBE LATCHES INTO PLACE IN THE HOLDER, INSIDE THE TUBE IS LIQUID HAND SANITZER WITH A HAND PUMP AT THE TOP., by Glenda Sidman, included by reference herein and for which benefit of the priority date is hereby claimed.

This application claims the benefit under 35 U.S.C. §119(e) of the U.S. provisional application(s) listed here as 60/807,583 filed on Jul. 17, 2006.

### FIELD OF THE INVENTION

The present invention relates to devices used to dispense sanitizing liquid gels for use in the general activity of killing harmful germs and, more particularly, devices used for dispensing liquid hand sanitizer liquid gel and paper towels, for use in preventing the spread of harmful germs and bacteria from the surface of human hands, which can otherwise be spread as the hands come in contact with surfaces, food, and other people, these germs and bacteria causing illnesses such as the common cold, flu, e-coli, norovirus and other illnesses, and these devices are designed to be placed on kitchen and/or restaurant countertops and/or tabletops for convenience and immediate access and use.

### BACKGROUND OF THE INVENTION

It is widely known that the spread of germs and harmful bacteria occurs often through hand contact. Germ and bacteria laden surfaces are invitations to busy hands that pick up these germs and bacteria upon contact with these surfaces and pass the germs and bacteria along to the next point of contact, whether it be a door handle, a restaurant menu, table tops and other surfaces, food and condiment dispensers and bottles, food, refrigerator handles, computer keyboards, books, documents, other paper products, school and office supplies, and of course other human contact, etc. So many illnesses such as the common cold, norovirus, flu, e-coli, and many more are caused by the spread of germs and bacteria. The more we encourage hand sanitation and make it readily available, the healthier we will be.

This invention can conveniently and easily be placed on any restaurant countertop or tabletop, any kitchen countertop or tabletop, and any place where prevention of the spread of germs is desired, such as bathrooms, bedrooms, playrooms, and other household environments, classrooms, and offices. Use of this device is convenient, fast, and easy. Anyone from young children to senior citizens can use it.

Also, while children and adults alike feast on finger foods, it is rare to see children in a restaurant run to the restroom to wash their hands before eating. Having this type of device right there on the table or counter will entice the children as well as adults to pump it and enjoy watching as it squirts the liquid sanitizer gel on their hands, then they can enjoy rubbing their hands together spreading throughout their hands the sanitizer gel to kill the germs and stop the spread of harmful bacteria before they put their hands and the food in their mouths. They will anticipate the fragrance and gladly use this device before and after eating.

Classrooms whose teachers encourage the use of this invention as students arrive in class and before students leave the room for lunch or snack time, after playing outside, recess, and homes equipped with kitchens that have this dispenser device coupled with Moms and Dads who encourage its use, will experience less illnesses, such as: colds, flu, e-coli, norovirus, and other harmful illnesses, caused by germs and bacteria.

There have been many devices and techniques designed for killing germs and bacteria and more specifically designed for killing germs and bacteria on one's hands. The original method for killing germs and bacteria was to use soap and water, then using a towel to dry your hands. While this method still works to kill germs and bacteria and prevent their spread, it usually requires that you leave the table or counter and/or room in which you are dining. Most people find it time consuming, and inconvenient and don't always choose to do so regularly prior to and after the meal. Also, soap and water are not as effective in killing germs and bacteria as most sanitizer gels available today.

There are several types of portable dispensers of liquid sanitizing gels that can be carried and used at any restaurant, home, classroom, office, car, or almost anywhere. However, these dispensers must be carried by someone on their person, taken out, and used in connection with napkins, paper towels, or toilet paper that must also be available at the time of use. Portable dispensers are generally small and insufficient in volume for repeated use. The level of difficulty required in purchasing, planning ahead, carrying it on you, getting the dispenser out, etc. has enough built in barriers that children and even some adults will not always use portable liquid sanitizing gel dispensers, thus continuing the spread of germs and bacteria.

Also, sanitizing or antiseptic hand wipes pose some of the same challenges, such as, a certain level of difficulty required in purchasing, planning ahead, carrying it on you, getting the wipes out, etc.

The fact that this device is readily available right within arm's reach and conveniently combines liquid sanitizing gel and/or antiseptic gel and the drying paper towel in one handy dispenser, makes its use much more practical on an everyday and every meal or snack basis.

There are currently known various devices for dispensing cleaning fluids, and wipers for use in cleaning such as those disclosed in U.S. Pat. No. 6,138,874. These are designed to dispense serious cleaning fluids used when cleaning houses and restaurants to kill germs and bacteria on hard surfaces and are not meant to be used for sanitizing hands prior to, during, and after meals. In fact most cleaning fluids these devices are designed to work with should not even be on your hands at meal time, or in many cases any time, as they are harmful when ingested, usually harmful to your skin, and certainly not used prior to and after meals. On the other hand, sanitizing gel is non-toxic.

While the other devices designed for surface cleaning do spray these industrial cleaning fluids using a spray pump mechanism, they do not contemplate dispensing gels as most of the usual household cleaners are liquid or solid. The hand sanitizers used with this device are gels. This device is specifically designed to be used for gels by attaching and utilizing the now commonly used hand sanitizer gel pump since both by weight and volume, gels are mostly liquid in composition and thus exhibit densities similar to liquids, however have the structural coherence of a solid. A gel is a colloidal system in which a porous network of interconnected nanoparticles spans the volume of a liquid medium. In general, gels are apparently solid, jelly-like materials. Both by weight and volume, gels are mostly liquid in composition and thus exhibit densities similar to liquids, however have the structural coherence of a solid.

Also, as gels differ in structure and properties from cleaning fluids they have different storage and containment needs. The other devices use the existing elongated neck and/or base as a reservoir for storing the fluids. This device uses separate replaceable gel pouch container tubes, which are completely separate, and fit inside the elongated cylindrical receptacle, and are removable for cleaning, refilling, and/or replacement.

It is therefore an object of the invention to prevent the spread of germs and bacteria via human hands that have been contaminated touching food, surfaces, and other infected areas.

It is another object of the invention to make it fast, easy, and convenient to sanitize your hands before, and after meals.

It is another object of the invention to encourage hand sanitation and make it more readily available and accessible.

It is another object of the invention to additionally provide an easy and convenient way to dispense products that when applied to the skin soften, moisturize, and repair the skin on your hands.

It is another object of the invention to additionally provide a convenient and easy, as well as, decorative way to provide a place for napkin holders and napkins, condiment trays, salt and pepper shakers, along with the liquid sanitizing gel dispenser and paper towels all in one convenient, accessible and decorative unit.

### SUMMARY OF THE INVENTION

In accordance with the present invention, there is provided a hand pump dispenser and holder for liquid sanitizer gels and paper towels that is both functional and decorative. The device has a sturdy weighted base. Attached to the base is an elongated cylindrical receptacle protruding from the center of the base which is not less than 6 inches high but preferably more than 11 inches high, that holds a paper towel roll vertically as the roll slips over the elongated cylindrical receptacle at the paper towel roll's central bore. The preferred embodiment base has non-slip padding on the bottom so that it doesn't slide when on a counter or table top. The base is connected at its top center area to the vertical hollow cylinder which is used to place a paper towel roll on for dispensing. A gel pouch container tube is inserted through the top hole of the vertical cylinder paper towel dispenser. The gel pouch container tube is attached to the hand pump assembly at the gel pouch container tube's top, by using the gel pouch connector to secure same together, the hand pump already has the straw like gel tube from the pump attached and this gel tube protrudes down through the center area of the gel pouch container tube. The gel tube which is attached to the hand pump is lowered and placed inside the gel pouch container tube and secured together by the gel pouch connector, then the entire pump assembly is lowered or slid into the snug fitting elongated cylindrical receptacle at the outlet aperture (or top end) of the elongated cylindrical receptacle and the assembly is latched securely into place at the top (outlet aperture) using the receptacle latch. The pump utilizes a dispenser nozzle end which reaches slightly past the radius of a full paper towel roll to deliver the liquid gel to your hands. Inside the gel pouch container tube is liquid gel hand sanitizer and the tube is attached to a hand pump at the top of the gel pouch container tube filled with liquid sanitizer gel. Liquid hand sanitizer is pumped up through the tube in the paper towel holder and dispenser for dispensing the gel into the palm area of the hands before and after meals. After lathering hands in the sanitizer the excess is wiped off the hands by using the paper towels. Slots for salt and pepper shakers, napkins and/or condiments can be added to the device. A fill screw and mechanism can be added to the elongated cylindrical receptacle for additional filling methods.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a hand pump dispenser and holder for dispensing liquid gels and paper towels in accordance with the invention;

FIG. 2 is a front view of more detailed images of parts of the hand pump dispenser and holder for dispensing liquid gels and paper towels shown in FIG. 1 which are shown separately here in FIG. 2 and that when assembled become the hand pump dispenser and holder for dispensing liquid gels and paper towels in accordance with the invention;

FIG. 3 is a cutaway view of a hand pump dispenser and holder for dispensing liquid gels and paper towels shown in FIG. 1 which shows in more detail the gel tube, gel, and gel pouch container tube;

FIG. 4 is a front view of a hand pump dispenser and holder for dispensing liquid gels and paper towels shown in FIG. 1 with the condiment slot, napkin holder, and salt and pepper slot added; and

FIG. 5 is a front view of more detailed images of parts shown separately that when assembled become the hand pump dispenser and holder for dispensing liquid gels and paper towels, which includes the condiment slot, napkin holder, and salt and pepper slots.

For purposes of clarity and brevity, like elements and components will bear the same designations and numbering throughout the Figures.

### DESCRIPTION OF THE PREFERRED EMBODIMENT

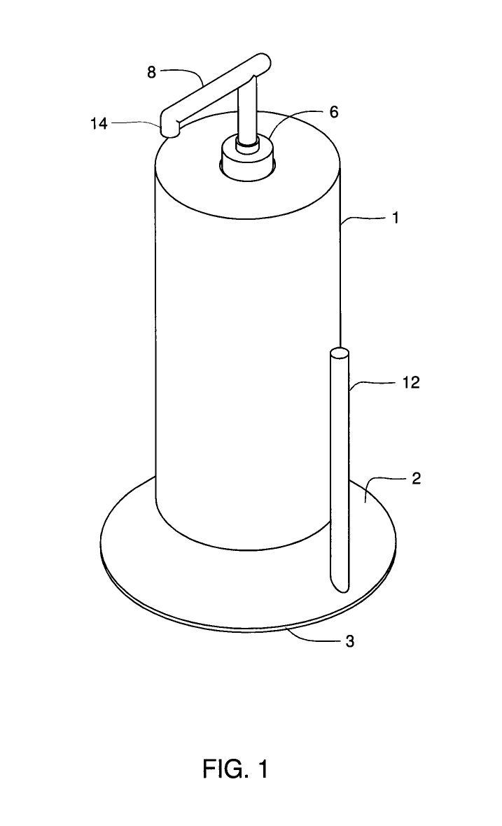

FIG. 1 is a front view of a hand pump dispenser and holder for dispensing liquid gels and paper towels in accordance with the invention.

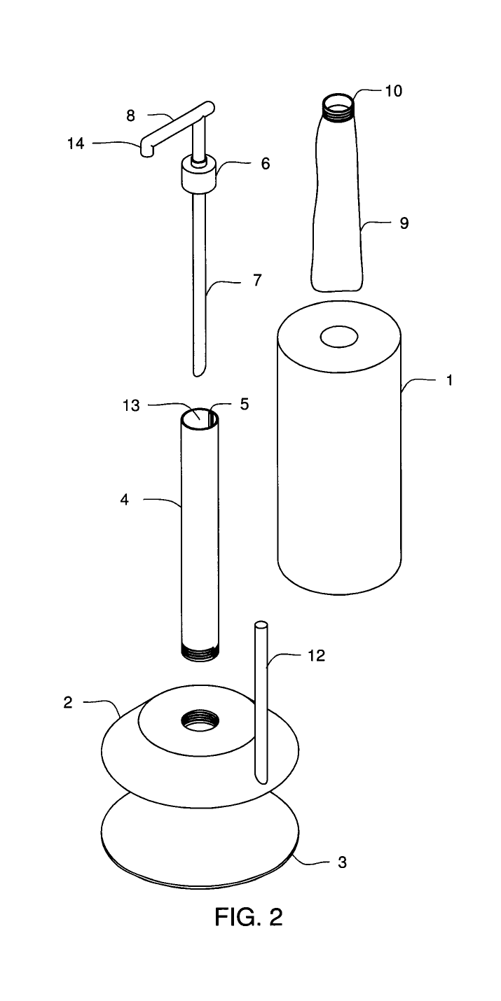

FIG. 2 is a front view of more detailed images of parts of the hand pump dispenser and holder for dispensing liquid gels and paper towels shown in FIG. 1 and described below which are shown separately here in FIG. 2 and that when assembled becomes the hand pump dispenser and holder for dispensing liquid gels and paper towels in accordance with the invention.

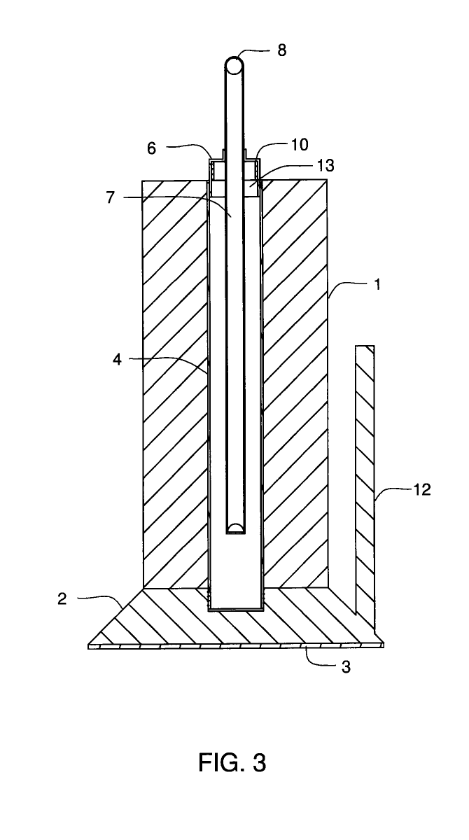

FIG. 3 is a cutaway view of a hand pump dispenser and holder for dispensing liquid gels and paper towels which shows the placement of the gel tube (7), liquid sanitizing gel, gel pouch connector (6), and the gel pouch container tube (9) within the elongated cylindrical receptacle (4).

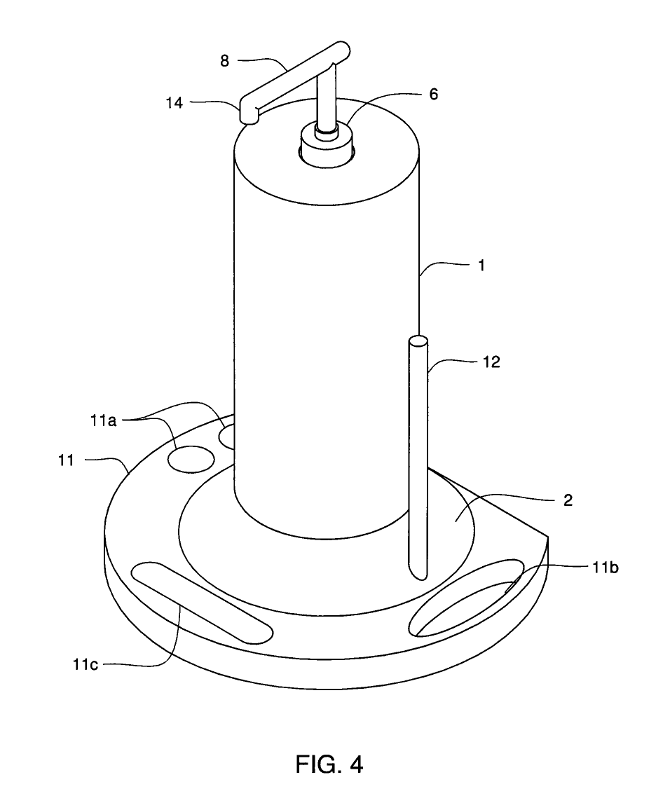

FIG. 4 is a front view of a hand pump dispenser and holder for dispensing liquid gels and paper towels shown in FIG. 1 with the condiment slot(s) (11a), napkin holder (11c), and salt and pepper shaker slot(s) (11b) added.

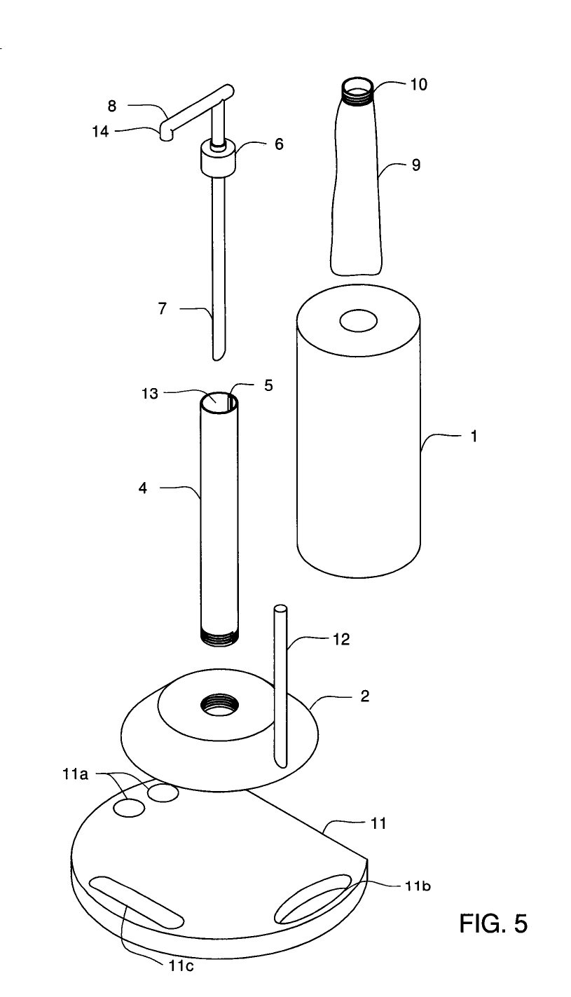

FIG. 5 is a front view of detailed images of the parts shown separately that when assembled become the hand pump dispenser and holder for dispensing liquid gels and paper towels shown in FIG. 4, which also includes the condiment slot (11a), napkin holder (11c), and salt and pepper slots (11b) added.

Referring to FIGS. 1 and 2, the hand pump dispenser and holder for dispensing liquid gels and paper towels consists of a base element (2) and a connected elongated cylindrical receptacle (4), and the elongated cylindrical receptacle (4) which extends upward above the paper towel roll (1), at this top end having an outlet aperture (13), receives a “pump assembly”. The “pump assembly” which consists of the hand pump (8), gel tube (7), gel pouch container tube (9) and gel pouch connector (6), which are all connected together to make the “pump assembly” using the gel pouch connector (6). The gel pouch container tube (9) holds liquid sanitizing gel and is filled with liquid sanitizing gel before the assembly is inserted and attached to the elongated cylindrical receptacle (4). A roll of paper towels (1) is placed on the elongated cylindrical receptacle (4). The “pump assembly” must first be removed or detached from the elongated cylindrical receptacle (4) prior to removing from the device, adding to the device, or replacing, a paper towel roll (1).

The gel pouch Container tube (9) may require a threaded section or attached piece (10) to secure it to the gel pouch connector (6).

The base element (2) is used to anchor the device for resting on top of a countertop or tabletop and therefore made to be sturdy and weighted so the device can stand upright and not wobble, tilt over or fall down. It can be hollow or solid.

The elongated cylindrical receptacle (4) is attached to the base element (2) at the top center of the base element (2) and protrudes up perpendicular from the center of the top of base element (2). The elongated cylindrical receptacle (4) is hollow and in the preferred impediment is more than 11 inches high. The top end of the elongated cylindrical receptacle (4) has been named the outlet aperture (13).

The preferred embodiment base element (2) has a soft textured non-slip padding (3) which is attached to the bottom of the base element (2) so that the device doesn't slide when on a counter or table top.

The elongated cylindrical receptacle (4) is sized to receive the central bore of the paper towel roll (1) which is placed over the top outlet aperture (13) of the elongated cylindrical receptacle (4) and slid down this shaft or rod until the bottom of the paper towel roll (1) touches the base element (2) which is attached to the elongated cylindrical receptacle (4). The paper towels are all attached to each other with perforated edges and wrapped around a central core of a cardboard tube having a central bore.

With the paper towel roll (1) installed on the elongated cylindrical receptacle (4) the user has a combination hand pump dispenser for dispensing liquid gels and a paper towels dispenser to wipe the user's hands thereafter.

The “pump assembly” is inserted through the top hole of the vertical cylinder paper towel dispenser known as the elongated cylindrical receptacle (4). This assembly consists of the gel pouch container tube (9), gel tube (7), hand pump (8), and gel pouch connector (6). The gel pouch container tube (9) is attached to the “hand pump assembly” (which consists of the hand pump (8), gel tube (7), and gel pouch connector (6) at the gel pouch container tube's top, by using the gel pouch connector (6) to secure same together, the hand pump (8) already has the straw like gel tube (7) from the pump attached and this gel tube (7) protrudes down through the center area of the gel pouch container tube (9). Together the “hand pump assembly” is lowered and placed inside the gel pouch container tube (9) and all secured together by the gel pouch connector (6), then the entire “pump assembly” is lowered or slid into the snug fitting elongated cylindrical receptacle (4) at the outlet aperture (13) (or top end) of the elongated cylindrical receptacle (4) and the “pump assembly” is latched securely into place at the top (outlet aperture (13)) using the receptacle latch (5). The gel pouch container tube (9) is filled with sanitizing gel before connecting to the “hand pump assembly”.

Liquid hand sanitizer is pumped up through the gel tube (7) in the gel pouch container tube (9) and hand pump (8) and dispenser nozzle end (14) for dispensing the gel into the palm area of the hands before and after meals. After lathering hands in the sanitizer the excess is wiped off the hands by using the paper towels which are on the paper towel roll (1) that is containing the paper towels to be dispensed.

The hand pump (8) is used for discharging doses of liquid sanitizing gel.

The dispenser nozzle end (14) of the hand pump (8) is the part of the hand pump (8) that reaches over and past the radius of a full paper towel roll (1) to deliver gel to one's hands when the hand pump (8) is triggered.

In the preferred embodiment the gel pouch container tube (9) is refillable.

The preferred embodiment also includes a tension rod (12) to prevent accidental paper towel over usage which is attached to the top of the base element (2) perpendicularly and is preferably at least six inches high and at a greater distance from the center of the base element (2) then the radius of a full paper towel roll (1). This element is not a required or essential element to the device.

FIG. 4 illustrates an alternate version of the hand pump dispenser and holder for dispensing liquid gels and paper towels with the condiment slot(s) (11a), napkin holder (11c), and salt and pepper shaker slot(s) (11b) added.

The preferred embodiment has these slots for salt and pepper shakers, napkins and condiments added to the device as one unit (11) which includes molded within it incisions for salt and pepper shaker slot(s) (11b), napkin holder (11c) and condiment slot(s) (11a). This unit is attached to the bottom of the base element (2) and has the non-slip padding (3) attached to the bottom of it instead of the non-slip padding (3) being attached to the base element (2).

FIG. 5 illustrates an alternate version of the detailed image of parts of the hand pump dispenser and holder for dispensing liquid gels and paper towels shown in FIG. 4 which are shown separately here in FIG. 5 and that when assembled become the hand pump dispenser and holder for dispensing liquid gels and paper towels in accordance with the invention and also including salt and pepper shaker slot(s) (11b), a napkin holder (11c) and condiment slot(s) (11a).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A hand pump dispenser and holder for dispensing liquid gels and paper towels for the prevention of the spread of germs and bacteria by sanitizing, wiping and drying the hands or other affected skin and body surface areas immediately after the hands or other body surface areas have made contact with germ and bacteria laden surfaces, thereby killing germs and bacteria before they have a chance to spread, comprising:
means for anchoring the device so it can stand;
means for holding a paper towel roll and allowing a gel pouch container tube, gel tube, hand pump, and gel pouch connector to be inserted therein. It is sized to receive the central bore of the paper towel roll for rotatably supporting the paper towel roll, securely attached to said means for anchoring the device so it can stand upright;
means for containing and storing the liquid sanitizing gel;
means for discharging doses of liquid sanitizing gel;
means for conducting liquid gel from the gel pouch container tube where it is stored to the hand pump, vertically connected to said means for discharging doses of liquid sanitizing gel, and mostly embedded within said means for containing and storing the liquid sanitizing gel;
means for being the place or location at the top end of the elongated cylindrical receptacle which is the area of the elongated cylindrical receptacle used for attaching and securing the gel pouch container tube and hand pump assembly to, which hand pump assembly has inserted into it said means for containing and storing the liquid sanitizing gel which has mostly embedded into it said means for conducting liquid gel from the gel pouch container tube where it is stored to the hand pump, and is essentially merged as the top area of said means for holding the paper towel roll and allowing the sanitizer gel pouch container tube, and pump assembly to be inserted therein, and is sized to receive the central bore of the paper towel roll for rotatably supporting the paper towel roll;
means for causing friction with any surface the device is placed on, so as to help prevent sliding, tilting, or falling over of the device, snugly adhered to said means for anchoring the device so it can stand upright;
means for securely connecting the gel pouch container tube, the hand pump, and said means for conducting liquid gel from the gel pouch container tube where it is stored to the hand pump, which is directly adhered to said means for discharging doses of liquid sanitizing gel, and securely attached to said means for containing and storing the liquid sanitizing gel;
means for holding in place the entire hand pump, gel tube, gel pouch connector, and gel pouch container tube “pump assembly”, once it has been inserted into the elongated cylindrical receptacle at the top outlet aperture, securely fastened to said means for securely connecting the gel pouch container tube to the hand pump, and securely fastened to said means for being the place or location at the top end of the elongated cylindrical receptacle for attaching and securing the gel pouch and hand pump apparatus to; and
means for reaching over and past the radius of a full paper towel roll to deliver liquid gel to one's hands when the hand pump is triggered, horizontally connected as part of said means for discharging doses of liquid sanitizing gel.

2. The hand pump dispenser and holder for dispensing liquid gels and paper towels in accordance with claim 1, wherein said means for anchoring the device so it can stand upright comprises a sturdy, weighted base element.

3. The hand pump dispenser and holder for dispensing liquid gels and paper towels in accordance with claim 1, wherein said means for holding the paper towel roll and allowing the sanitizer gel pouch container tube, gel tube, and pump assembly to be inserted therein is which is sized to receive the central bore of the paper towel roll for rotatably supporting the paper towel roll comprises a hollow, cylindrical elongated tube, extending upwardly from the center of the top of the base element and having at its upper end an outlet aperture.

4. The hand pump dispenser and holder for dispensing liquid gels and paper towels in accordance with claim 1, wherein said means for containing and storing the liquid sanitizing gel comprises an expandable pouch container called a gel pouch container tube.

5. The hand pump dispenser and holder for dispensing liquid gels and paper towels in accordance with claim 1, wherein said means for discharging doses of liquid sanitizing gel comprises a hand pump.

6. The hand pump dispenser and holder for dispensing liquid gels and paper towels in accordance with claim 1, wherein said means for conducting liquid gel from the gel pouch container tube where it is stored to the hand pump comprises a tube, which extends into the fluid chamber, and is a conduit for liquid gel to travel through called a gel tube.

7. The hand pump dispenser and holder for dispensing liquid gels and paper towels in accordance with claim 1, wherein said means for securely connecting the gel pouch container tube to the hand pump comprises a gel pouch connector.

8. The hand pump dispenser and holder for dispensing liquid gels and paper towels in accordance with claim 1, wherein said means for holding in place the entire hand pump and gel pouch container tube assemble, once it has been inserted into the elongated cylindrical receptacle at the outlet aperture comprises a locking device which clips and holds it together which is a receptacle latch.

9. The hand pump dispenser and holder for dispensing liquid gels and paper towels in accordance with claim 1, wherein said means for reaching over and past the radius of a full paper towel roll to deliver liquid gel to one's hands when the hand pump is triggered comprises a dispenser nozzle end.

10. A hand pump dispenser and holder for dispensing liquid gels and paper towels for the prevention of the spread of germs and bacteria by sanitizing, wiping and drying the hands or other affected skin and body surface areas immediately after the hands or other body surface areas have made contact with germ and bacteria laden surfaces, thereby killing germs and bacteria before they have a chance to spread, comprising: a sturdy, weighted base element, for anchoring the device so it can stand upright and not wobble, tilt over or fall down;
a hollow, cylindrical elongated tube, extending upwardly from the center of the top of the base element, having at its upper end an outlet aperture, for holding the paper towel roll and allowing the sanitizer gel pouch container tube, gel tube, and pump assembly to be inserted therein, this elongated cylindrical receptacle is sized to receive the central bore of the paper towel roll for rotatably supporting the paper towel roll, securely and perpendicularly attached to said base element;
an expandable gel pouch container tube, for containing and storing the liquid sanitizing gel;
a hand pump, for discharging doses of liquid sanitizing gel;
a tube, which extends into the fluid chamber, a conduit for liquid gel to travel through gel tube, for conducting liquid gel from the gel pouch container tube where it is stored to the hand pump, vertically connected to said hand pump, and mostly embedded into said gel pouch container tube;
an outlet aperture, which is the place or location at the top end of the elongated cylindrical receptacle for attaching and securing the gel pouch container tube, gel tube, and hand pump assembly to, and essentially merged as the top most part of said elongated cylindrical receptacle;
a soft textured pad, which causes surface friction, a non-slip padding, used for causing friction with any surface the device is placed on, so as to help prevent sliding, tilting, or falling over of the device, snugly adhered to said base element;
a gel pouch connector, for securely connecting the gel pouch container tube to the hand pump, and to said gel tube, directly adhered to said hand pump and gel tube, and securely attached to said gel pouch container tube;
a receptacle latch locking device, that clips and holds together parts, which is used for holding in place the entire hand pump and gel pouch container tube assembly, once it has been inserted into the elongated cylindrical receptacle at the top outlet aperture, securely fastened to said gel pouch connector, and securely fastened to said outlet aperture; and
the hand pump having a dispenser nozzle end, for reaching over and past the radius of a full paper towel roll to deliver liquid gel to one's hands when the hand pump is triggered, horizontally connected to said hand pump.

11. The hand pump dispenser and holder for dispensing liquid gels and paper towels as recited in claim 10, further comprising:
a condiment slot(s), for adding condiment storage and service areas to the device, securely connected to said base element.

12. The hand pump dispenser and holder for dispensing liquid gels and paper towels as recited in claim 10, further comprising:
a salt and pepper shaker slot(s), for adding storage and service areas for salt and pepper shakers to the device, securely connected to said base element.

13. The hand pump dispenser and holder for dispensing liquid gels and paper towels as recited in claim 10, further comprising:
a napkin holder, for adding storage and service area for napkins to the device, securely connected to said base element.

14. The hand pump dispenser and holder for dispensing liquid gels and paper towels as recited in claim 10, further comprising:
a tension rod, for preventing accidental excess paper towel usage, perpendicularly attached to said base element.

15. The hand pump dispenser and holder for dispensing liquid gels and paper towels as recited in claim 1, wherein said gel pouch container tube is refillable.

16. The hand pump dispenser and holder for dispensing liquid gels and paper towels as recited in claim 10, wherein said gel pouch container tube is refillable.

17. The hand pump dispenser and holder for dispensing liquid gels and paper towels as recited in claim 10, wherein said gel pouch container tube has a threaded top section to secure it to the said gel pouch connector.

18. The hand pump dispenser and holder for dispensing liquid gels and paper towels as recited in claim 10, wherein said gel pouch container tube has a threaded top attached piece to secure it to the said gel pouch connector.

19. A hand pump dispenser and holder for dispensing liquid gels and paper towels for the prevention of the spread of germs and bacteria by sanitizing, wiping and drying the hands or other affected skin and body surface areas immediately after the hands or other body surface areas have made contact with germ and bacteria laden surfaces, thereby killing germs and bacteria before they have a chance to spread, comprising: a sturdy, weighted base element, for anchoring the device so it can stand upright and not wobble, tilt over or fall down;
a hollow, cylindrical elongated tube, extending upwardly from the center of the top of the base element, having at its upper end an outlet aperture, for holding the paper towel roll and allowing the sanitizer gel pouch container tube, gel tube, and pump assembly to be inserted therein. Said elongated cylindrical receptacle is sized to receive the central bore of the paper towel roll for rotatably supporting the paper towel roll, and is securely attached to said base element;
an expandable, refillable gel pouch container tube, for containing and storing the liquid sanitizing gel;
a handy hand pump, for discharging doses of liquid sanitizing gel;
a tube, which extends into the fluid chamber, which is a conduit for liquid gel to travel through, for conducting liquid gel from the gel pouch container tube where it is stored to the hand pump, vertically connected to said hand pump, and protruding down into said gel pouch container tube;
an outlet aperture, the place or location at the top end of the elongated cylindrical receptacle, for attaching and securing the gel pouch and hand pump assembly to, and essentially merged to, as part of, said elongated cylindrical receptacle;
a soft textured pad, which causes surface friction, a non-slip padding, for causing friction with any surface the device is placed on, so as to prevent sliding, tilting, or falling over of the device, snugly adhered to said base element;
a gel pouch connector, for securely connecting the gel pouch container tube, and gel tube, to the hand pump, which is directly adhered to said gel tube and said hand pump, and securely attached to said gel pouch container tube;
a receptacle latch locking device which clips and holds together parts, for holding in place the entire hand pump and gel pouch container tube pump assembly, once it has been inserted into the elongated cylindrical receptacle at the outlet aperture, securely fastened to said gel pouch connector, and securely fastened to said outlet aperture;
a dispenser nozzle end, for reaching over and past the radius of a full paper towel roll to deliver liquid gel to one's hands when the hand pump is triggered, horizontally connected to said hand pump;
a condiment slot(s), for adding condiment storage and service areas to the device, securely connected to said base element;
a salt and pepper shaker slot(s), for adding storage and service areas for salt and pepper shakers to the device, securely connected to said base element;
a napkin holder, for adding storage and service area for napkins to the device, securely connected to said base element; and
a tension rod, for preventing accidental excess paper towel usage, perpendicularly attached to said base element.
